(19) United States
(12) Patent Application Publication
(10) Pub. No.: US 2019/0341169 A1
(43) Pub. Date: Nov. 7, 2019

(54) COMMMUNICATION CABLE, CABLE FORMING LINE, AND METHOD

(71) Applicants: James F. Rivernider, JR., Ware, MA (US); Jason L. Sterndale, Fiskdale, MA (US)

(72) Inventors: James F. Rivernider, JR., Ware, MA (US); Jason L. Sterndale, Fiskdale, MA (US)

(21) Appl. No.: 16/427,222

(22) Filed: May 30, 2019

Related U.S. Application Data
(63) Continuation of application No. 16/058,880, filed on Aug. 8, 2018, now abandoned.
Application No. 16/058,880 is a continuation of application No. 15/159,508, filed on May 19, 2016, now abandoned.

(51) Int. Cl. H01B 11/02; H01B 13/22; H01B 11/08; H01B 11/00; H01B 13/02

(52) U.S. Cl. CPC H01B 11/02; H01B 13/22; H01B 13/0278; H01B 11/002; H01B 11/08

(57) ABSTRACT

A twisted pair cabling line and method comprising, a source of at least two twisted pairs, a source of planar shield, a cabling station, that combines the twisted pairs and the shield into a non-twisted cable, a twisting station that twists the cable that is produced by the cabling station, a twisting space between the cabling station and the twisting station, in which the non-twisted cable produced by the cabling station is twisted, to thereby form the shield into a figure-8 cross section having two loops, with a twisted pair in each loop, and a cable storage station.

### CROSS-REFERENCE TO RELATED APPLICATIONS

This application claims the benefit under 35 U.S.C. sections 119(e) and 120 of U.S. Provisional patent application No. 61/771,667 filed Mar. 1, 2013, and Non-Provisional patent application Ser. No. 14/194,791, filed on Mar. 2, 2014, now U.S. Pat. No. 9,355,759, issued May 31, 2016, Non-Provisional patent application Ser. No. 15/163,617, filed May 24, 2016, and Non-Provisional patent application Ser. No. 15/159,508, filed May 19, 2016, all of which are hereby incorporated by reference.

### STATEMENT REGARDING FEDERALLY SPONSORED RESEARCH OR DEVELOPMENT

This invention has been created without the sponsorship or funding of any federally sponsored research or development program.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

A current challenge to cable manufacturers is to produce a cable that avoids “spikes” in Near End Crosstalk (NEXT) and Far end Crosstalk (FEXT) at transmission frequencies up to 2 Ghz. Crosstalk is the result of radiational coupling between twisted wire pairs situated in close proximity to each other. A situation that must be minimized in digital transmission cables. It is believed that repetitions in the cable lays (occurring naturally or resulting from manufacturing defects) cause coupling to add constructively, resulting in “spikes” in near end and/or farend crosstalk at certain frequencies.

In a current four pair cable using Unshielded Twisted Pair (UTP) or using Foil Shielded Twisted Pair (F/UTP) there are 6 combinations of possible twisted pair/twisted pair radiational interaction: (1) pair one to pair two, (2) pair one to pair three, (3) pair one to pair four, (4) pair two to pair three, (5) pair two to pair four) and (6) pair three to pair four. These combinations must be constructed with the spacing of repetitions or defects being outside the desired frequency range of the cable. The spacing of repetitions or defects must be greater than half the wavelength of the highest frequency of interest. Finding a suitable spacing of repetitions or defects is difficult when the frequency range is more than 500 Mhz because the shorter wavelength makes for fewer possible lay combinations that do not repeat in the given frequency range.

One solution is to shield all four twisted wire pair to eliminate coupling. The drawback of this solution is the increased size of the cable and the increased size of the twisted wire pairs themselves. In order to produce an individually shielded twisted wire pair with the required impedance, the insulation thickness of the wire must be significantly greater than that which is necessary for an unshielded twisted wire pair cable having the same impedance. This increases the overall cost, size, and stiffness of the cable.

Another solution is to increase the size or thickness of a separator or filler used to assure an appropriate distance is maintained between the twisted wire pairs. However, this method also increases the overall size and stiffness of the cable.

A further solution is for the manufacturer to intentionally vary the twisted wire pair lays during the cable construction. This method, however, complicates the manufacturing operation, making the setup more difficult and increasing the chance of errors during the setup and construction of the cable.

The applicant's proposed design requires only one or two twisted wire pair combinations because a radiation shield isolates the twisted wire pairs into two groups of two twisted wire pairs each. The applicant's unique method of applying the radiation shield eliminates from consideration four (or possibly five) of the theoretical radiationally significant twisted wire pair interactions. The only interactions required to consider are (1) and (6) from the list of possible combinations noted above. In other words, the combination options are reduced to: twisted wire pair one combined with twisted wire pair two and separately, twisted wire pair three combined with twisted wire pair four.

It is, furthermore, possible that the particular lay combination of twisted wire pair one to twisted wire pair two can be used in the construction of both groups of twisted wire pairs without this causing NEXT and FEXT spike issues. The applicant's unique method of applying the radiation shield also reduces the need to increase the insulation thickness in order to achieve the desired impedance because the shield is applied in a relatively loose manner around the twisted wire pair groups.

### BRIEF SUMMARY OF THE INVENTION

This category 8 cable is meant for use in high speed Ethernet applications having up to a 40 Gbit/sec data rate, with a frequency range of the cable extending to at least 2 GHz. Performance parameters for this cable are expected to extend to at least 2 Ghz. This includes near end crosstalk parameters.

### BRIEF DESCRIPTION OF THE SEVERAL VIEWS OF THE DRAWINGS

FIG. 1 is a cross-sectional view of a communication cable embodying the principles present invention.

FIG. 2 is a cross-sectional view of another communication cable embodying the principles of the present invention.

FIG. 3 is a cross-sectional view of another communication cable embodying the principles of the present invention.

FIG. 4 is a front elevation view of cable forming line equipment embodying the principles of the present invention.

FIG. 5 is a cross-sectional view of a cable forming tool embodying the principles of the present invention.

FIG. 6 is an elevation view of the upstream side of the cable forming tool, shown in FIG. 5, and embodying the principles of the present invention.

FIG. 7 is an elevation view of the downstream side of the cable forming tool, shown in FIG. 5, embodying the principles of the present invention.

FIG. 8 is a cross-sectional view, taken along line 8-8 of FIG. 5, showing the lens shaped opening in the tool, shown in FIG. 5, embodying the principles of the present invention.

FIG. 9 is a cross-sectional view, taken along line 9-9, as shown in FIG. 4.

FIG. 10 is a cross-sectional view, taken along line half-way between line 9-9 and line 11-11, as shown in FIG. 4.

FIG. 11 is a cross-sectional view, taken along line 11-11, as shown in FIG. 4.

FIG. 12 is a cross-sectional view, taken along line 12-12, as shown in FIG. 4.

FIG. 13 is a cross-sectional view, taken along line 13-13, as shown in FIG. 4.

FIG. 14 is a cross-sectional view, taken along line 14-14, as shown in FIG. 4.

FIG. 15 is a cross-sectional view, taken along line 15-15, as shown in FIG. 4.

FIG. 16 is a cross-sectional view, taken along line 16-16, as shown in FIG. 4.

### DETAILED DESCRIPTION OF THE INVENTION

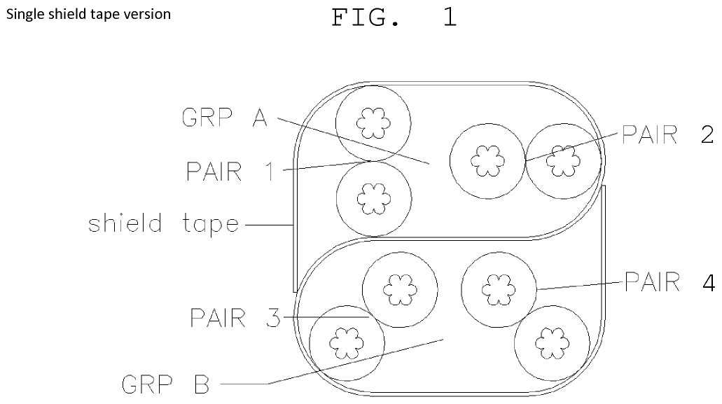

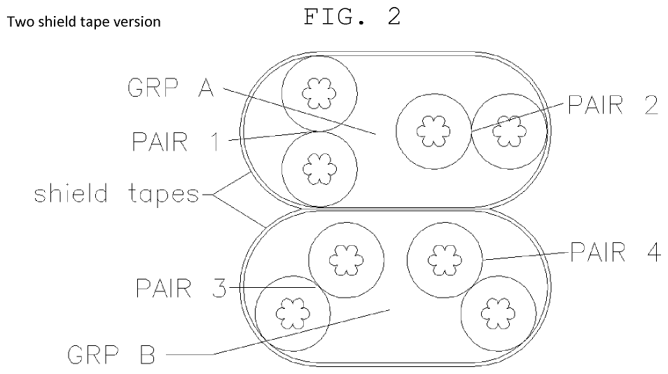

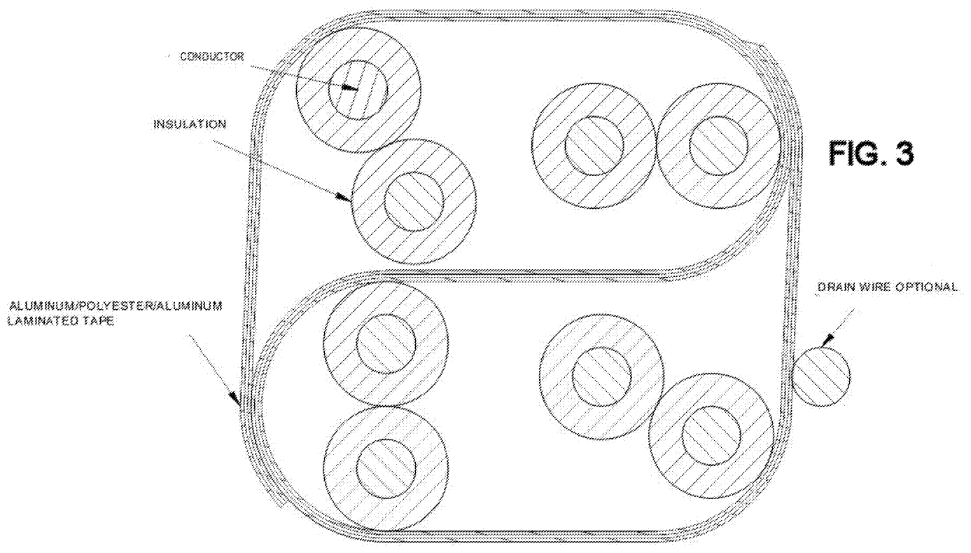

One embodiment of the instant invention as shown in FIG. 1 is a Category 8 Cable consisting of two wire groups, A and B, with two twisted wire pairs in each group, pair 1 and 2 in group A, and pair 3 and 4 in group B. Each individual wire, of the twisted wire pairs, is insulated with a solid or foamed polymer (for example: HDPE). The cable core, consisting of the two wire groups, A and B, is wrapped with at least one shield tape in an “S” arrangement as shown in FIG. 1. The single shield tape wraps around each group and passes between them. A standard PVC cable jacket, not shown in the FIG. 1 or 2, surrounds the entire core.

Alternatively, in another embodiment a second shield tape surrounds the first shield tape and both wire groups.

As shown in FIG. 2, another embodiment of the invention employs two separate foil shield tapes, each surrounding one of the two wire groups, A and B, making up the cable core. This alternative construction provides two layers of foil shield tape between the two wire groups A and B.

Each wire group A and B consists of two twisted pairs 1-4, the lay of each individual twisted pair in a group being different from the other in the same group. Furthermore, each lay is calibrated in such a way as to minimize radiational interference between the two twisted pairs in a group. Coupling interference between the two groups A and B is minimized by the foil shield tape, making it possible for the lays in group A to be identical to the lays in group B without an increase in radiational interference.

The lays in group A can alternatively be different from the lays in group B provided that lay combinations within each group are chosen so as to minimize the susceptibility of constructive addition between the proximate twisted wire pairs. Because of the foil shield tape, negative interactions between group A and group B are eliminated.

In a further embodiment, a foil shield tape surrounds group A while another foil shield tape surrounds both group A and B simultaneously. And, in a still further embodiment, a foil shield tape surrounds group A while another shield forms an integral part of the outer jacket that surrounds both group A and B.

As discussed above, there are significant benefits to four pair data cables that use varied lays (twist rate) or individually shielded pairs to minimize crosstalk. Over very broad frequency ranges, 1 Mhz to 2 Ghz in this case, it is difficult to find 4 pair lays that do not have a natural repetition or a repetition caused by the manufacturing process, such as a periodic variation in the twist, that causes high crosstalk at a specific frequency within the desired frequency range. By dividing the cable into two groups isolated by a shield, only 2 twist combinations without repetitions are required. Individually shielded pair cable can be constructed by applying tape to each pair or by using a single “s” shaped tape to isolate each pair.

This requires that the insulated OD of the wires be larger to get the desired characteristic impedance. That also requires that more 2 or 4 shields be removed at termination. Cable is made with any size stranded or solid wire, generally 28 AWG through 22 AWG. Insulation can be any dielectric that is low loss and has the proper dielectric constant for the dimensions to produce the desired impedance applied by standard means. Pairs are twisted with right or left hand lays. We have used pair lay lengths in the range of 6.5 to 15 mm. 2 groups of 2 lays or 4 unique lays can be used. Pairs are grouped with a single shield applied in an “5”. This produces two groups of two pair. The shield is applied so that it does not wrap around an individual pair more than 180 degrees.

The preferred shield tape is Aluminum/polyester/Aluminum to give the maximum shielding effectiveness and isolation of the pair groups. Other shield types would work. Anything that provides shielding between 1 and 2 Ghz could work. Shield tapes that are not continuous are common in the industry. There are lots of patents on these types of tapes, 2 cited by the examiner are US2006/0048961 and U.S. Pat. No. 7,332,676.) Color code for the pairs is arranged for termination. Preferred is Blue and Orange are in one shield cavity and green and brown are in the other shield cavity to produce the lowest possible crosstalk between blue and green which are the middle pairs in a RJ-45 pinout.

Shield is formed by a tool used to bring the pairs together with the foil between the two groups. There is a slot that guides the shield tape between the two groups. The opening that the pairs pass through is not circular. The standard wire and cable industry practice in shape is circular. The shape is formed by the intersection of two circles producing a lens shape. The diameter of the circles is 1.0 to 1.1 times the cable diameter. The circles intersect such that the smaller dimension of the lens shape is 0.75 to 0.9 times the diameter of the circles. As the cable rotates and is twisted together the tape forms an S dividing the cable into two groups of two pairs. The width of the tape is such that the tape overlaps itself to enclose the two pair groups. The rest of the process for putting the cable together (called cabling or bunching) is standard wire and cable industry practice so the outside dimensions of the tool, angle of the cone in the tool or radius depends on the rest of the set up and can be modified. Cited patents 4773976 and 6211459 have to do with shielding material. 6566606, 2001/0040042, 6288340 and DE29719866 have multiple tapes. We originally had multiple tapes as one option but we definitely do not want to do that now. 2006/0048961 and 7332676 are the discontinuous tapes I mention above. This would work with our construction. I don't see these two conflicting with what we claim. I think the key feature is the single tape whether it is continuous or not.

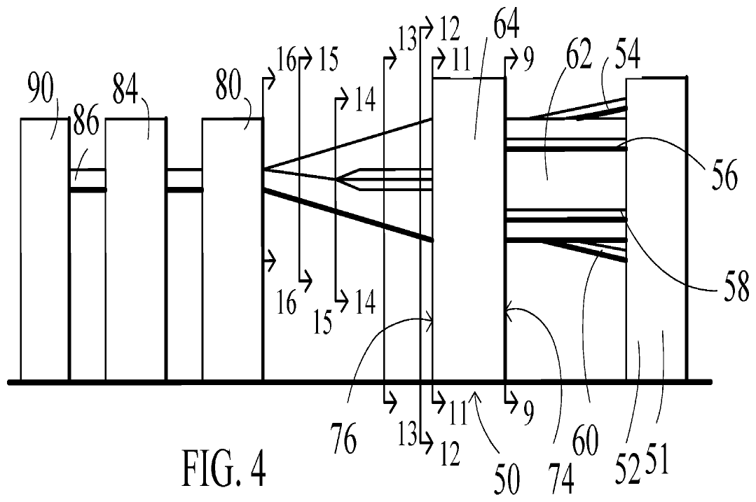

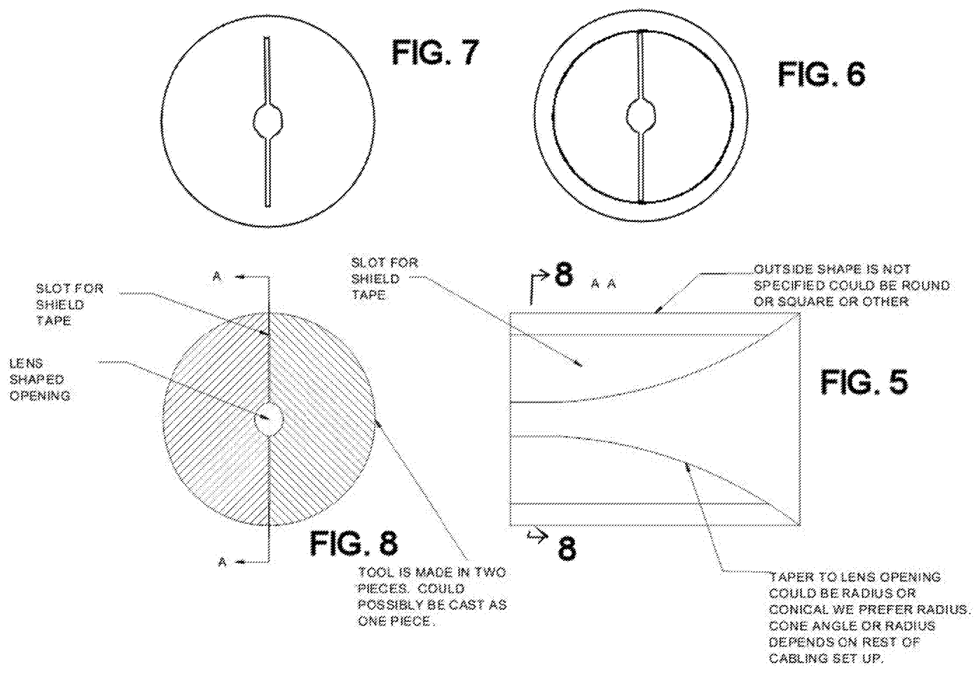

The cable formation line 50, as shown in FIG. 4, includes a twisted-pair source 51, and a shield source 52. The four twisted pairs 54, 56, 58, and 60, and the shield 62, are fed to the cabling machine 64, which combines the twisted pairs and the shield into the desired structure. In this case, the four twisted pairs are fed to the cabling machine with two on each side of the planar shield. The cabling machine has a conic central bore 66 with a large diameter upstream opening 68 into which is a cable is feed and a small downstream opening 70 from which the cable emerges.

The cabling machine 64 also has a vertical slot 72 concentric with the central bore 66 and passing completely from the upstream side 74 of the cabling machine 64 to the downstream side 76. This slot 72 allows the shield 62 to pass through the cabling machine 64 in a planar condition and also pass through the large diameter opening 68 and the small opening 70 of the central bore 66.

When the shield passes through the central bore, and out the downstream side 76, two twisted pairs are positioned on each side of the planar shield 62.

Between the downstream side 76 of the cabling machine 64 and a cable twisting machine 80, is a twisting space 82. The cable twisting machine 80 twists, over the twisting space 82, the output of the cabling machine 64 and thereby forms the shield into an S-shaped cross-section, or more accurately a figure-8 cross-section.

From the twisting machine 80, the twisted cable is then fed into the jacketing machine 84 which puts the protective outer layer 86 on the cable. The finished cable is feed to the storage system 90.

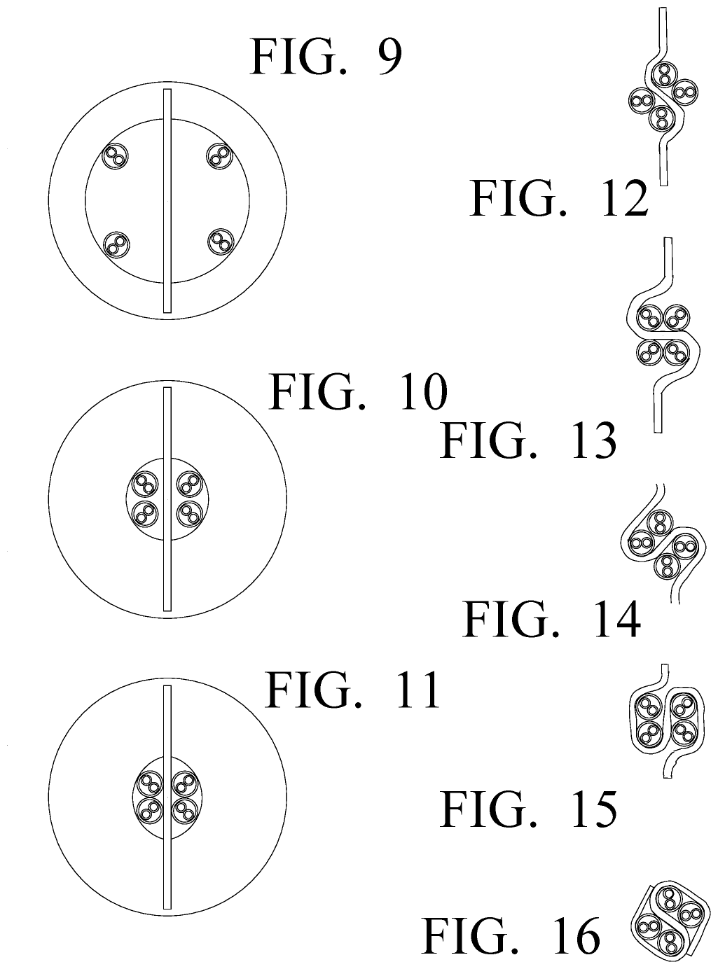

The process of forming the shield in the twisting space is best understood by the sequence of cross-sectional views starting with FIG. 9.

FIG. 9 shows the cross-sectional view of the shield and for pairs entering the upstream side of the cabling machine.

FIG. 10 shows the cross-sectional view of the shield and four pairs between the upstream side and the downstream side of the cabling machine.

FIG. 11 shows the cross-sectional view of the shield and four pairs exiting the downstream side of the cabling machine, Through a lens shaped opening.

The lens shaped (non-circular) opening functions to prevent the shield and the 4 twisted pairs from twisting as they exit the cabling machine. However, the downstream twisting machine causes the shield and 4 twisted pairs to immediately start to twist as they exit the downstream opening of the cabling machine.

FIG. 12 is a cross-sectional view which shows the effect of the twisting of the shield and for twisted pairs soon after exiting the downstream opening of the tool and after 45° of rotation. The shield is formed into an S-shaped cross-section. For clarity, this view is presented as a cross-section without the presentation of background.

FIG. 13 is a cross-sectional view which shows the further effect of the twisting of the shield and four twisted pairs after a second 45° of rotation. The shield is further formed into an S-shaped cross-section. For clarity, this view is presented as a cross-section without the presentation of background.

FIG. 14 is a cross-sectional view which shows the further effect of the twisting of the shield and four twisted pairs after a third 45° of rotation. The shield is further formed into an S-shaped cross-section. For clarity, this view is presented as a cross-section without the presentation of background.

FIG. 15 is a cross-sectional view which shows the further effect of the twisting of the shield and four twisted pairs after a fourth 45° of rotation. The shield is further formed into an S-shaped cross-section. For clarity, this view is presented as a cross-section without the presentation of background.

FIG. 16 is a cross-sectional view which shows the further effect of the twisting of the shield and four twisted pairs after a fifth 45° of rotation. The shield is further formed into an S-shaped cross-section or perhaps more accurately, a figure-8 cross-section. For clarity, this view is presented as a cross-section without the presentation of background.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A twisted pair cabling line, comprising:
a. a source of at least two twisted pairs,
b. a source of planar shield,
c. a cabling station, that combines the twisted pairs and the shield into a non-twisted cable,
d. a twisting station that twists the cable that is produced by the cabling station,
e. a twisting space between the cabling station and the twisting station, in which the non-twisted cable produced by the cabling station is twisted, to thereby form the shield into a figure-8 cross section having two loops, with a twisted pair in each loop, and
e. a cable storage station.

2. A twisted pair cabling line as recited in claim 1, wherein there are four twisted pairs, with two on each side of the shield.

3. A twisted pair cabling line as recited in claim 1, wherein the cabling station has an exit port that does not allow the exiting cable to twist while it is in the exit port.

4. A twisted pair cabling line as recited in claim 1, wherein the cabling station has an exit port that has a non-circular cross section.

5. A twisted pair cabling line as recited in claim 1, wherein the cabling station has an exit port that has a lense-shaped cross section.

6. A method of forming a shielded twisted pair cable, comprising the steps of:
a. providing at least two twisted pairs,
b. providing a source of planar shield,
c. providing a cabling station, that combines the twisted pairs and the shield into a non-twisted cable,
d. providing a twisting station that twists the cable that is produced by the cabling station,
e. providing a twisting space between the cabling station and the twisting station, in which the non-twisted cable produced by the cabling station is twisted, to thereby form the shield into a figure-8 cross section having two loops, with a twisted pair in each loop, and
e. providing a cable storage station.
